(19) United States
(12) Patent Application Publication
(10) Pub. No.: US 2003/0214685 A1
(43) Pub. Date: Nov. 20, 2003

(54) Image forming apparatus and image forming method

(75) Inventor: Kazuhisa Suzuki, Sagamihara-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/147,999

(22) Filed: May 20, 2002

(51) Int. Cl. H04N 1/04; G06F 15/00; B41J 1/00

(52) U.S. Cl. 358/488; 358/1.18

(57) ABSTRACT

When an image on a regular-sheet original is to be printed on a tab sheet, setting of tab sheet printing and an associated tab width amount and tab sheet shift amount are input. A main CPU executes a control to add white data to image data in a page memory by an amount corresponding to the tab sheet shift amount, and executes a control to effect printing on the tab sheet.

### BACKGROUND OF THE INVENTION

The present invention relates to an image forming apparatus such as a digital copying machine and an image forming method, wherein an image on an original is read to produce an image.

In the prior art, when printing is effected on a tab sheet, sheet convey and image shift control are performed on the basis of tab width information that is the only set information.

In general, in the print function for printing on a tab sheet, it is presupposed that the original has a fixed size (standard size). In addition, in order that printing can be effected on a tab portion (projecting portion) of a tab sheet on which printing is to be effected, an image to be formed on the tab sheet is shifted by a difference between the fixed size and the size of the tab sheet.

When image shifting is effected by using tab width information set as a physical sheet size of the tab sheet, the amount of the image shift corresponds to the tab width and printing is performed with the image shift.

In this method, for example, when an operator finely adjusts an image to be shifted in the right-and-left, the operator alters the read position of the original on the original stable on the scanner.

In addition, when the original read position is not altered, the setting of the tab width amount is varied.

For example, in the case where the physical sheet size including the tab portion is to be set by the sheet convey control, if a size different from the actual size is set as a tab width amount, paper jam may occur during conveying the sheet. Besides, if a process for image development in the page memory is performed, partial lacking of an image may occur.

There is a conventional image shift function represented by a function of providing a margin for binding. If the binding margin function is substituted, not only an image to be printed on a tab sheet but also an image to be printed on a standard-size sheet is similarly shifted.

If all sheets for printing are tab sheets, the binding margin function may be substituted. However, this function is improper in the case of a job in which printing is intermittently effected on a tab sheet while printing is effected on standard-size sheets.

These methods are effective when paper sheets are basically of the fixed size.

However, when a tab sheet is used as an original, image shifting is needless. Thus, the applications of the image shift process using the tab width amount are limited.

### BRIEF SUMMARY OF THE INVENTION

The object of the present invention is to provide an image forming apparatus and an image forming method capable of adjusting an image shift process for tab sheets.

The present invention may provide an image forming apparatus wherein a regular paper sheet or a tab sheet is fed and an image is formed on the fed regular paper sheet or tab sheet, the apparatus comprising: an input section which inputs a tab width amount and a tab sheet shift amount when formation of an image on the tab sheet is set; a read section that reads an image on an original, which is to be formed on the tab sheet; a first control section which executes a control to shift the image data of the original read by the read section by the tab sheet shift amount input by the input section; and a second control section which executes a control to form an image on the tab sheet on the basis of the image data shift-controlled by the first control section.

This invention may provide an image forming method wherein a regular paper sheet or a tab sheet is fed and an image is formed on the fed regular paper sheet or tab sheet, the method comprising: inputting a tab width amount and a tab sheet shift amount when formation of an image on the tab sheet is set; reading an image on an original, which is to be formed on the tab sheet; shifting the image data of the read original by the tab sheet shift amount; and executing a control to form an image on the tab sheet on the basis of the shifted image data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a cross-sectional view showing an internal structure of a digital copying machine according to an image forming apparatus of the present invention;

FIG. 2 is a plan view showing the structure of an operation panel;

FIG. 3 is a block diagram schematically showing the structure of the digital copying machine;

FIG. 4 is a view for explaining settings of printing on a tab sheet according to the invention;

FIG. 5 shows an example of display on an LCD section on the operation panel;

FIG. 6 is a flow chart illustrating a printing operation for copying an image of a standard-sheet original onto a tab sheet;

FIG. 7 is a flow chart illustrating a printing operation for copying an image of a tab-sheet original onto a tab sheet;

FIG. 8 is a flow chart illustrating a printing operation for printing on a tab sheet when the apparatus is used as a network printer; and

FIG. 9 shows an example of display for setting a tab width amount and a tab-sheet shift amount on a personal computer screen.

### DETAILED DESCRIPTION OF THE INVENTION

An embodiment of the present invention will now be described with reference to the accompanying drawings.

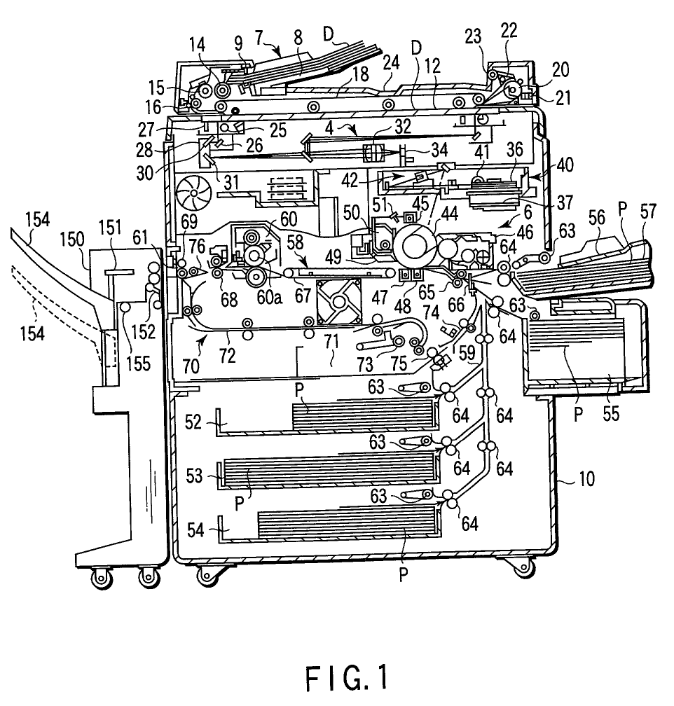

FIG. 1 is a cross-sectional view showing an internal structure of a digital copying machine (DPPC) according to an image forming apparatus of the present invention.

As is shown in FIG. 1, the digital copying machine has an apparatus main body 10. The apparatus main body 10 incorporates a scanner section 4 functioning as an image read section and a printer section 6 functioning as an image forming section.

An original table 12 formed of transparent glass, on which a read object, i.e. an original D is placed, is disposed on the upper surface of the apparatus main body 10. An automatic document feeder 7 (hereinafter referred to as “ADF”) for automatically feeding originals onto the original table 12 is disposed on the upper surface of the apparatus main body 10. The ADF 7 is disposed to be opened/closed with respect to the original table 12 and serves as an original cover for bringing the original D placed on the original table 12 into close contact with the original table 12.

The ADF 7 has an original tray 8 on which the original D is set; an empty sensor 9; pickup rollers 14 for picking up originals on the original tray 8 one by one; a feed roller 15 for conveying the picked-up original; an aligning roller pair 16 for aligning the leading edges of the originals; and a conveyor belt 18 disposed to cover almost the entire surface of the original table 12. A plurality of originals set on the original tray 8 with their surfaces facing up are sequentially taken out from the lowermost page, i.e. the last page, aligned by the aligning roller pair 16, and conveyed to a predetermined position on the original table 12 by the conveyor belt 18.

In the ADF 7, a reversing roller 20, a non-reverse sensor 21, a flapper 22 and a delivery roller 23 are disposed at the end portion on the opposite side of the aligning roller pair 16 with respect to the conveyor belt 18. The original D whose image information has been read by the scanner section 4 (to be described later) is fed from the original table 12 by the conveyor belt 18 and delivered to an original delivery section 24 on the ADF 7 through the reversing roller 20, flapper 21 and delivery roller 22. To read the lower surface of the original D, the flapper 22 is switched. The original D conveyed by the conveyor belt 18 is reversed by the reversing roller 20 and fed to a predetermined position on the original table 12 again by the conveyor belt 18.

The scanner section 4 provided in the apparatus main body 10 has an exposure lamp 25 as a light source for illuminating the original D placed on the original table 12, and a first mirror 26 for deflecting reflection light from the original D in a predetermined direction. The exposure lamp 25 and first mirror 26 are attached to a first carriage 27 disposed under the original table 12.

The first carriage 27 is disposed to be movable in parallel to the original table 12 and reciprocally moved under the original table 12 by a scanning motor through a toothed belt (not shown), etc.

A second carriage 28 movable in parallel to the original table 12 is disposed under the original table 12. Second and third mirrors 30 and 31 for successively deflecting reflection light from the original D, which has been deflected by the first mirror 26, are attached to the second carriage 28 at right angles with each other. The second carriage 28 is moved by, e.g. the toothed belt for driving the first carriage 27 along with the first carriage 27, and moved in parallel along the original table 12 at half the speed of the first carriage 27.

A focusing lens 32 for focusing reflection light from the third mirror 31 mounted on the second carriage 28, and a CCD (photoelectric conversion element) 34 for receiving the reflected light focused by the focusing lens and photoelectrically converting it are also disposed under the original table 12. The focusing lens 32 is disposed in a plane including the optical axis of the light deflected by the third mirror 31 so as to be movable by means of a driving mechanism. The focusing lens 32 moves to focus the reflection light at a desired magnification. The CCD 34 photoelectrically converts the incoming reflection light and outputs an electrical signal corresponding to the read original D.

On the other hand, the printer section 6 has a laser exposure unit 40 functioning as a latent image forming means. The laser exposure unit 40 comprises a semiconductor laser 41 as a light source; a polygon mirror 36 as a scanning member for continuously deflecting a laser beam emitted by the semiconductor laser 41; a polygon motor 37 as a scanning motor for rotatably driving the polygon mirror 36 at a predetermined rotational speed; and an optical system 42 for deflecting the laser beam from the polygon mirror 36 and guiding the beam to a photosensitive drum 44 (to be described later). The laser exposure unit 40 with the above structure is fixed to a support frame (not shown) of the apparatus main body 10.

The semiconductor laser 41 is ON/OFF-controlled in accordance with the image information of the original D read by the scanner section 4 or facsimile transmission/reception document information. The laser beam is directed to the photosensitive drum 44 through the polygon mirror 36 and optical system 42 to scan the outer surface of the photosensitive drum 44, thereby forming an electrostatic latent image on the outer peripheral surface of the photosensitive drum 44.

The printer section 6 has the rotatable photosensitive drum 44 as an image carrier disposed almost at the center of the apparatus main body 10. The outer peripheral surface of the photosensitive drum 44 is exposed to the laser beam from the laser exposure unit 40, and so a desired electrostatic latent image is formed thereon. Around the photosensitive drum 44, the following elements are arranged in the named order: a charger 45 for electrifying the outer peripheral surface of the drum 44 with a predetermined charge; a developing device 46 for supplying toner as a developer to the electrostatic latent image formed on the outer peripheral surface of the photosensitive drum 44 to develop it at a desired image density; a transfer charger 48, which integrally includes a separation charger 47 for separating an image formation medium, i.e. a paper sheet P, fed from a paper cassette (to be described later) from the photosensitive drum 44, and transfers the toner image formed on the photosensitive drum 44 onto the paper sheet P; a separation gripper 49 for separating the paper sheet P from the outer peripheral surface of the photosensitive drum 44; a cleaning unit 50 for removing toner remaining on the outer peripheral surface of the photosensitive drum 44; and a charge erase device 51 for erasing charge on the outer peripheral surface of the photosensitive drum 44.

An upper sheet cassette 52, a middle sheet cassette 53 and a lower sheet cassette 54 which can be drawn out of the apparatus main body 10 are stacked at the lower portion of the apparatus main body 10. These cassettes 52 to 54 store paper sheets P of different sizes. A large-capacity feeder 55 is disposed on one side of these cassettes. This large-capacity feeder 55 stores about 3,000 paper sheets P having a size with high use frequency, e.g. paper sheets P with A4 size. A feed cassette 57 also serving as a manual feed tray 56 is detachably attached above the large-capacity feeder 55.

A convey path 58 extending from the sheet cassettes and large-capacity feeder 55 through a transfer section located between the photosensitive drum 44 and transfer charger 48 is formed in the apparatus main body 10. A fixing unit 60 having a fixing lamp 60a is disposed at the end of the convey path 58. A delivery port 61 is formed in the side wall of the apparatus main body 10, which is opposed to the fixing unit 60. A single-tray finisher 150 is attached to the delivery port 61.

Pickup rollers 63 for taking out the paper sheets P one by one from the sheet cassette 52, 53, 54, 57 or large-capacity feeder 55 are arranged near each of the upper sheet cassette 52, middle sheet cassette 53, lower sheet cassette 54 and feed cassette 57 and near the large-capacity feeder 55. A number of feed roller pairs 64 for conveying the paper sheet P taken out by the pickup rollers 63 through the convey path 58 are arranged in the convey path 58.

A registration roller pair 65 is arranged in the convey path 58 on the upstream side of the photosensitive drum 44. The registration roller pair 65 corrects a tilt of the extracted paper sheet P, registers the leading edge of the toner image on the photosensitive drum 44 and the leading edge of the paper sheet P, and feeds the paper sheet P to the transfer section at the same speed as the speed of movement of the outer peripheral surface of the photosensitive drum 44. A prealigning sensor 66 for detecting arrival of the paper sheet P is provided in front of the registration roller pair 65, i.e. on the feed roller 64 side.

Each paper sheet P extracted one by one from the sheet cassette, 52, 53, 54, 57 or large-capacity feeder 55 by the pickup rollers 63 is fed to the registration roller pair 65 by the feed roller pair 64. After the leading edge of the paper sheet P is aligned by the registration roller pair 65, the paper sheet P is fed to the transfer section.

In the transfer section, a developer image, i.e. toner image formed on the photosensitive drum 44 is transferred onto the paper sheet P by the transfer charger 48. The paper sheet P on which the toner image has been transferred is separated from the outer peripheral surface of the photosensitive drum 44 by the function of the separation charger 47 and separation gripper 49 and conveyed to the fixing unit 60 through a conveyor belt 67 constituting part of the convey path 58. After the developer image is melted and fixed on the paper sheet P by the fixing unit 60, the copying paper sheet P is delivered onto the finisher 150 through the delivery port 61 by a feed roller pair 68 and a delivery roller pair 69.

An automatic double-side unit 70 for reversing the paper sheet P which has passed through the fixing unit 60 and feeding it to the registration roller pair 65 again is provided under the convey path 58. The automatic double-side unit 70 comprises a temporary stack 71 for temporarily stacking the paper sheets P; a reversing path 72 branched from the convey path 58 to reverse the paper sheet P which has passed through the fixing unit 60 and to guide the paper sheet P to the temporary stack 71; pickup rollers 73 for extracting the paper sheets P stacked on the temporary stack one by one; and a feed roller 75 for feeding the extracted paper sheet P to the registration roller pair 65 through a convey path 74. A selector gate 76 for selectively distributing the paper sheets P to the delivery port 61 or reversing path 72 is provided at the branch portion between the convey path 58 and reversing path 72.

Where double-copying is performed, the paper sheet P which has passed through the fixing unit 60 is guided to the reversing path 72 by the selector gate 76, temporarily stacked on the temporary stack 71 in a reversed state, and fed to the registration roller pair 65 through the convey path 74 by the pickup rollers 73 and feed roller 75. The paper sheet P is registered by the registration roller pair 65 and fed to the transfer section again to transfer a toner image onto the reverse surface of the paper sheet P. Thereafter, the paper sheet P is delivered to the finisher 150 through the convey path 58, fixing unit 60 and delivery rollers 69.

The finisher 150 staples delivered copies of documents and stores them in units of a copy. Each time a paper sheet P to be stapled has been delivered from the delivery port 61, a guide bar 151 aligns the paper sheet P to the stapling side. When all paper sheets have been delivered, a copy of paper sheets P is pressed by a paper press arm 152 and stapled by a stapler unit (not shown). Then the guide bar 151 moves downward. The stapled paper sheets P are delivered to a finisher delivery tray 154 by a finisher delivery roller 155 in units of a copy. The downward movement amount of the finisher delivery tray 154 is roughly determined in accordance with the number of paper sheets P to be delivered, and the finisher delivery tray 154 moves downward stepwise every time one copy is delivered. The guide bar 151 for aligning the delivered paper sheets P is located at such a high position that the guide bar 151 may not abut upon the already stapled paper sheets P placed on the finisher delivery tray 154.

The finisher delivery tray 154 is connected to a shift mechanism (not shown) which shifts (e.g. in four directions: front, rear, left and right sides) in units of a copy in the sort mode.

An operation panel 80 for inputting various copy conditions, a copy start signal for starting copying operations, etc. is provided at the upper portion on the front side of the apparatus main body 10.

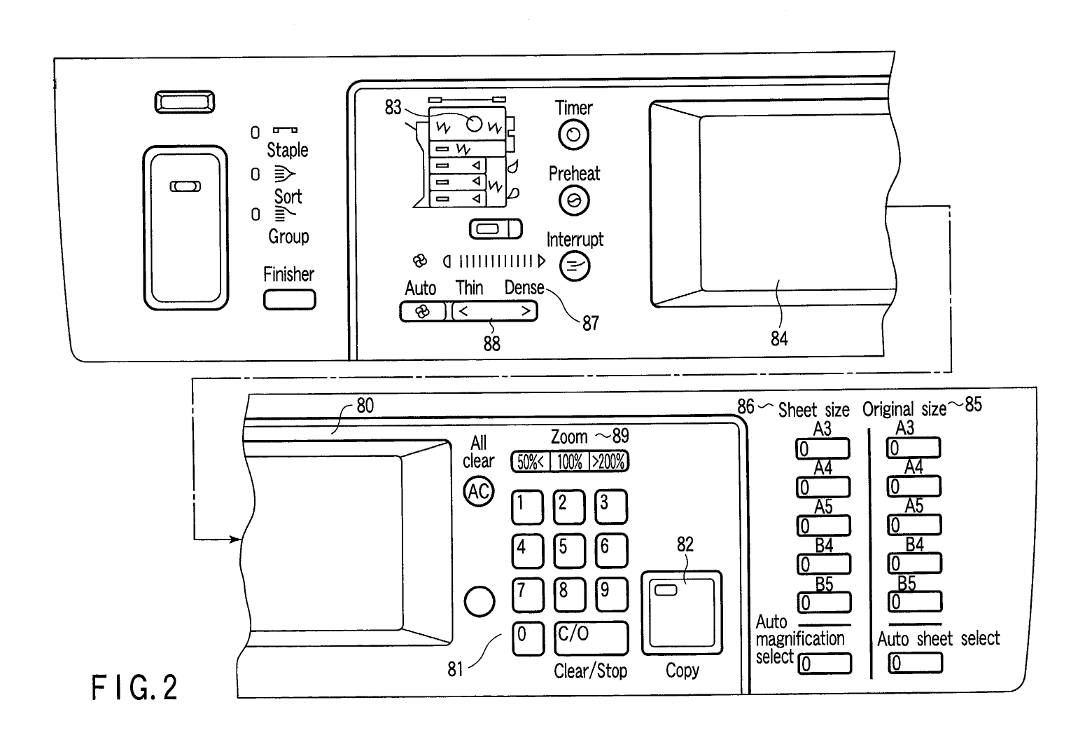

As is shown in FIG. 2, the operation panel 80 comprises numeral keys 81, a copy key 82, a state display section 83, a liquid crystal display section 84, an original key size setting key 85, a sheet size setting key 86, a density display section 87, a density setting key 88, and a magnification setting key 89.

The numeral keys 81 are used to set the number of originals, or the number of copies.

The copy key 82 is used to instruct the start of copying.

The state display section 83 displays guidance on the state of selection of the sheet feed cassette, jamming of an original or a paper sheet, etc.

The liquid crystal display section 84 displays the number of originals and the number of copies, and also displays the copying magnification, editing, and various operational guidances. The liquid crystal display section 84 is provided with a touch panel, which enables input of various operational instructions, such as input by selection keys. For example, it displays selection keys for a photomode, a character mode and a character/photo mode as original modes, and permits input thereof.

The original size setting key 85 is used to set the size of the original D.

The sheet size setting key 86 is used to set the size of the sheet P.

The density display section 87 displays the copy density set by the density setting key 88.

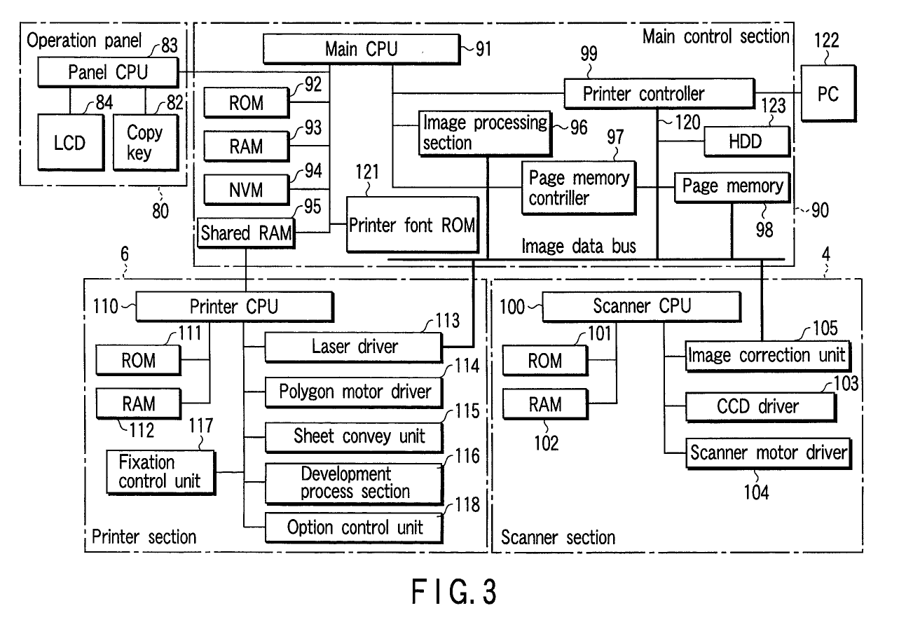

FIG. 3 is a block diagram schematically showing electrical connection of the digital copying machine shown in FIG. 1 and flow of signals for control. In FIG. 3, a control system comprises three CPUs: a main CPU 91 provided in a main control section 90; a scanner CPU 100 in the scanner section 4; and a printer CPU 110 in the printer section 6. The main CPU 91 performs bidirectional communication with the printer CPU 110 via a shared RAM 95. The main CPU 91 issues an operational instruction, and the printer CPU 110 returns status data. Serial communication is performed between the printer CPU 110 and scanner CPU 100. The printer CPU 110 issues an operational instruction, and the scanner CPU 100 returns status data.

The operation panel 80 is connected to the main CPU 91.

The main control section 90 comprises the main CPU 91, a ROM 92, a RAM 93, an NVRAM 94, a shared RAM 95, an image processing unit 96, a page memory control unit 97, a page memory 98, a printer controller 99, and a printer font ROM 121.

The main CPU 91 controls the entirety of the main control section 90. The ROM 92 stores control programs, etc.

The RAM 93 temporarily stores various data.

The NVM (Non-Volatile RAM) 94 is a non-volatile memory backed up by a battery (not shown). Even when power is not supplied to the NVM 94, stored data is maintained.

The shared RAM 95 is used to perform bidirectional communication between the main CPU 91 and printer CPU 110.

The page memory controller 97 stores and reads out image information in and from the page memory 98. The page memory 98 has areas capable of storing image information of a plurality of pages. The page memory 98 can store compressed data in units of a page, which is obtained by compressing image information from the scanner section 4.

The printer font ROM 121 stores font data corresponding to print data.

The printer controller 99 develops document data, which is sent from a personal computer (PC) 122, into image data using the font data stored in the printer font ROM 121 with a resolution corresponding to resolution data added to the document data.

A hard disc drive (HDD) 123 stores an original image in the form of a file, or electronic data

The scanner section 4 comprises the scanner CPU 100 for controlling the entirety of the scanner section 4; a ROM 101 storing control programs, etc.; a data storage RAM 102; a CCD driver 103 for driving the CCD sensor 34; a scan motor driver 104 for controlling the rotation of a scan motor for moving the exposure lamp 25, mirrors 26, 27 and 28, etc.; and an image correction unit 105. The image correction section 105 comprises an A/D converter for converting analog signals output from the CCD sensor 34 to digital signals; a shading correction circuit for correcting a variance in the CCD sensor 34, or a variation in threshold level due to ambient temperature variation relative to the output signal from the CCD sensor 34; and a line memory for temporarily storing shading-corrected digital signals from the shading correction circuit.

The printer section 6 comprises the printer CPU 110 for controlling the entirety of the printer section 6; a ROM 111 storing control programs, etc.; a data storage RAM 112; a laser driver 113 for driving the semiconductor laser 41; a polygon motor driver 114 (motor control device) for controlling the rotation of the polygon motor 37 of the laser exposure unit 40; a sheet convey unit 115 for controlling conveyance of the sheet P by the convey mechanism 58; a process control section 116 for controlling charging, developing and transferring processes using the charging device 45, developing device 46 and transfer charger 48; a fixation control unit 117 for controlling the fixing device 60; and an option control unit 118 for control options.

The image process section 96, page memory 98, printer controller 99, image correction section 105, laser driver 113 and HDD 123 are connected over an image data bus 120.

In the present invention, an image shift amount for printing on a tab sheet can be adjusted by using not only tab width information but also tab sheet shift information.

The indispensable structural elements for realizing the function of the present invention are the following:

The operation panel 80 serving as user interface means for selecting and setting functions such as a copying function and a network printer function;

the RAM 93 functioning as job parameter storing means for storing information set through the operation panel 80 and various setting information necessary for inputting an original and forming a print image;

the page memory 98 or HDD 123 for storing, as files, an original image scanned by the scanner section 4 serving as original input means, or electronic data transmitted via a network, etc.;

the image processing unit 96 serving as print image forming means for editing and processing the file-formatted image in units of a page;

the page memory 98 serving as a memory area necessary for editing and processing the image; and

the print/conveyance control means for printing and conveying the print image developed in the page memory 98 onto the actual sheet, and printer section 6 functioning as the image forming mechanism.

The tab width amount and tab sheet shift amount are input and set through the operation panel 80.

The panel CPU 83 of operation panel 80 stores the information of the set tab width amount and tab sheet shift amount in the RAM 93.

The image forming apparatus has a plurality of sheet feed stages (sheet feed cassettes and large-capacity feeder), as mentioned above. When different tab sheets are to be set in different sheet feed stages, this operation mode is realized by using the operation panel 80, which permits setting of tab width amounts and tab sheet shift amounts for the respective sheet feed stages, and the RAM 93 serving as job parameter storing means.

In the case of the scan function in the copying operation of the scanner section 4, scanning can be performed even with use of sheets, such as tab sheets, having sizes different from fixed sizes. When an image on a tab sheet original is copied onto a tab sheet, there is no difference in sheet size and a problem will arise if an image shift is effected. Thus, by setting the shift amount at 0 mm, printing can be effected on the tab sheet without image shifting.

When the apparatus is used as a network printer via the printer controller 99, document formation is generally performed by application software (especially, word-processing software) used in the client PC 122 on the presupposition that paper sheets are of standard size.

In most of printer drivers, the entire area of a physical sheet size is not set as a printable area. In general, an area less than the physical size by about 2 mm is set as a printable area. As will be described later, when a document prepared in this environment is to be printed on a tab sheet, it is necessary to shift an image by a degree greater than a tab width.

A print image of file-formatted image data is developed in the page memory 98 by the page memory control unit 97. In this case, a tab width stored in the RAM 93 is added to the size set in the page memory 98.

For example, printing is to be effected on an A4-size sheet, an area of 210 mm×297 mm is set in the page memory 98. If the tab width is set at 13 mm and printing is to be effected on an A4-size tab sheet, an area of 223 mm×297 mm is set. In this way, the area corresponding to the physical sheet size is set and the file-format image data is developed in the page memory 98.

Subsequently, printing is effected on the actual sheet by the print/convey control means and the printer section 6 constituted by the image forming mechanism.

A description will now be given of a general printer.

When printing is effected on a tab sheet in the printer, if the shift amount is 0 mm, shift control is not executed. Image data in the page memory is read from a print start time point, and print control is executed.

If the shift amount is 15 mm, white data corresponding to a width of 15 mm is added to image data and developed in the page memory. Then, the image data in the page memory is read and print control is executed. Thereby, an image shift control is realized.

In the sheet convey control, when the actual sheet size does not coincide with the size handled in the control, the timing of feeding the next sheet, for instance, is affected and paper jamming may occur.

Since the tab width is used for the sheet convey control, it is necessary to set the size information corresponding to the actual size, and not the size for shifting.

As stated above, exact sheet size information may be required in the control method, depending on the print image forming method and sheet convey control method. When printing is effected on a sheet of a particular size, such as a tab sheet, by using such a control method, it is effective to independently store the information on image shifting.

In the prior-art image forming apparatus, an image shift function represented by a binding margin provision function is prepared in advance. Using this function, image shifting for tab-sheet printing may be performed.

However, in this method, in the case of a job in which printing is intermittently effected on a tab sheet while printing is effected on regular-size sheets, the binding margin provision function is insufficient. The reason is that there is a difference between the binding margin amount added to the image data to be printed on regular-size sheets and the binding margin amount added to the image data to be printed on tab sheets.

Under the circumstances, it is necessary to provide a function in which a tab sheet shift amount is newly set, apart from the setting of a tab width amount. This is the point of the present invention.

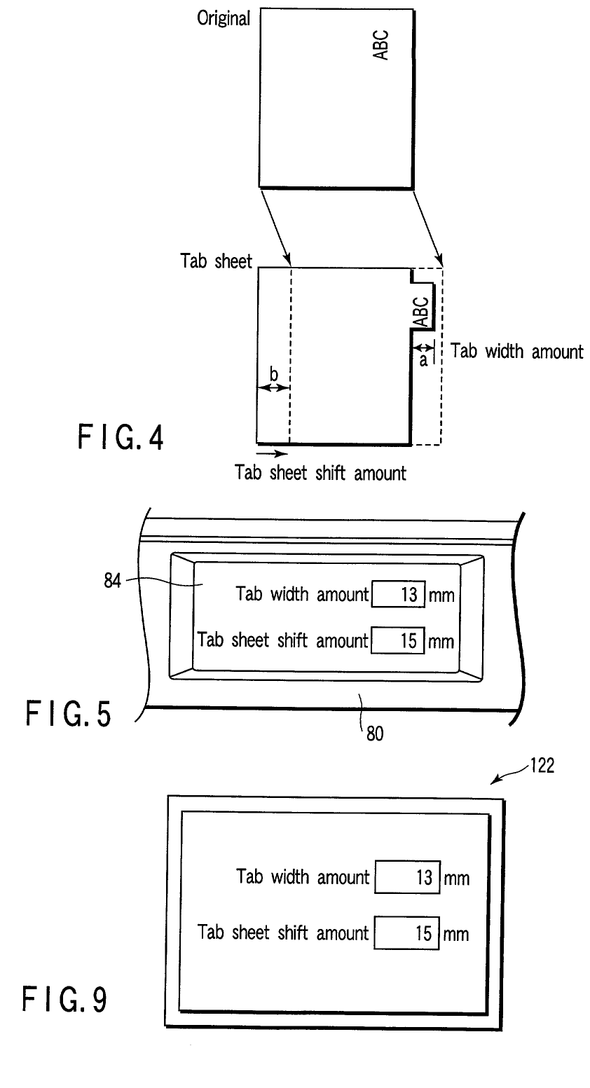

FIG. 4 is a view for explaining settings of printing on a tab sheet according to the invention. Specifically, when an image on a regular-size original is printed on a tab sheet, a tab width amount a and a tab sheet shift amount b are set.

FIG. 5 shows an example of display on the liquid crystal display section on the operation panel 80, wherein the tab width amount and tab sheet shift amount are set. In this example, the tab width amount is set at 13 mm and the tab sheet shift amount is set at 15 mm through the numeral keys 81.

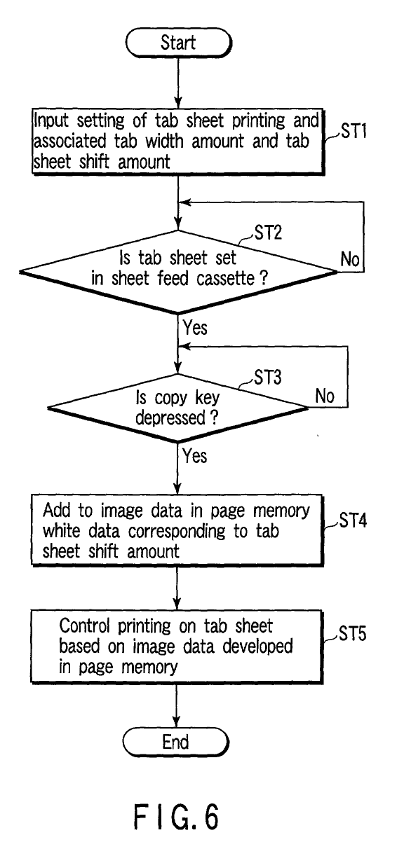

A printing operation for copying an image of a regular-size sheet original onto a tab sheet in the above structure will now be described with reference to a flow chart of FIG. 6.

When an image on a regular-size sheet original is to be printed on a tab sheet, the setting of a tab sheet printing, a tab width amount and a tab sheet shift amount are input through the operation panel 80 (ST1).

For example, the tab sheet is set in the sheet feed cassette 57, and the tab sheet is fed from the sheet feed cassette 57 (ST2). Printing on the tab sheet is set through the liquid crystal display section 84 of operation panel 80.

Assume that the tab width amount is set at 13 mm and the tab sheet shift amount at 15 mm through the numeral keys 81, as shown in FIG. 5. These data items are stored in the RAM 93.

In this case, since the tab width amount is 13 mm and the tab sheet shift amount is 15 mm, the image is shifted by 15 mm that is the tab sheet shift amount.

For example, when printing is effected on an A4-size tab sheet, the tab sheet shift amount is 15 mm and thus the area of 225 mm×297 mm is set in the page memory 98. In this manner, the area corresponding to the physical sheet size is set, and file-format image data is developed in the page memory 98.

When the copy key 82 has been depressed to instruct the copy start (ST3), the main CPU 91 executes a control to read out the information on the tab width amount and tab sheet shift amount from the RAM 93 and to add to the image data in the page memory 98 white data corresponding to the width of 15 mm of the tab sheet shift amount (ST4).

The image shifting in the present invention is not limited to the above method. In short, it should suffice if the image on the original is shifted and printed on the tab sheet as shown in FIG. 4.

After the image data is developed in the page memory 98, the main CPU 91 controls the printer section 6 to effect printing on the tab sheet based on the image data developed in the page memory 98 (ST5).

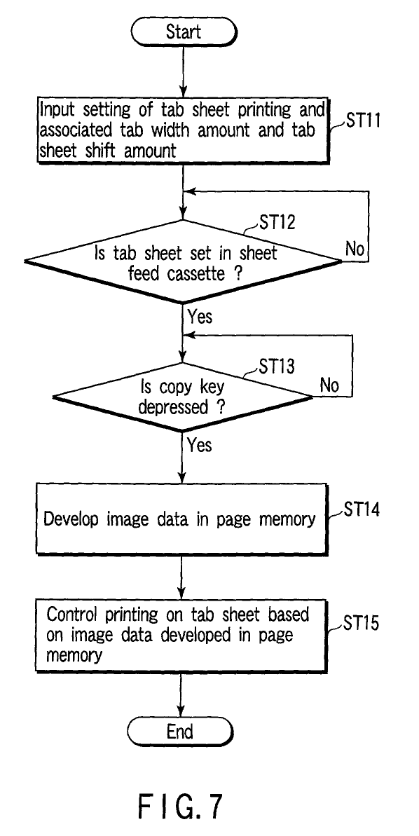

A printing operation for copying an image of a tab-sheet original onto a tab sheet will now be described with reference to a flow chart of FIG. 7.

When an image on a regular-size sheet original is to be printed on a tab sheet, the setting of a tab sheet printing, a tab width amount and a tab sheet shift amount are input through the operation panel 80 (ST1).

For example, the tab sheet is set in the sheet feed cassette 57, and the tab sheet is fed from the sheet feed cassette 57 (ST12). Printing on the tab sheet is set through the liquid crystal display section 84 of operation panel 80.

For example, when a tab sheet is the original, both the tab width amount and tab sheet shift amount, which are 0 mm, are input through the numeral keys 81. These data items are input in the RAM 93.

In this case, image shifting is needless.

When the copy key 82 has been depressed to instruct the copy start (ST13), the main CPU 91 reads out the information on the tab width amount and tab sheet shift amount from the RAM 93. Since both amounts are 0 mm, image data is developed in the page memory 98 (ST14).

Subsequently, the main CPU 91 controls the printer section 6 to effect printing on the tab sheet based on the image data developed in the page memory 98 (ST15).

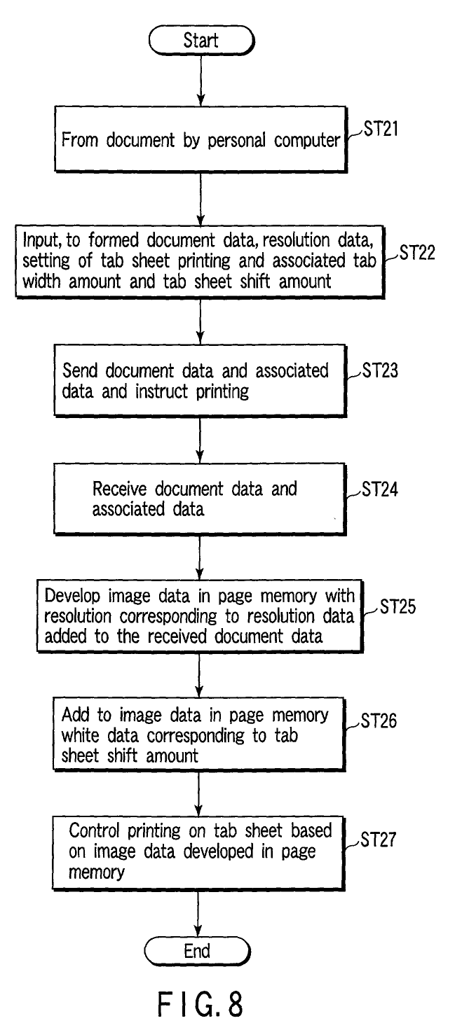

A printing operation for printing on a tab sheet when the apparatus is used as a network printer will now be described with reference to a flow chart of FIG. 8.

Document formation is generally performed by application software (especially, word-processing software) used in the client PC 122 on the presupposition that paper sheets are of standard size (ST21).

The client adds, to the document data (e.g. A4-size) prepared by the PC 122, resolution data as well as the setting of printing on the tab sheet, the associated tab width amount data and tab sheet shift amount data (ST22).

FIG. 9 shows an example of display for setting a tab width amount and a tab-sheet shift amount on the screen of the personal computer 122. In this example, the tab width amount, which is 13 mm, and the tab sheet shift amount, which is 15 mm, are input through the keyboard (not shown).

The client sends the document data and associated data from the PC 122 and instructs printing (ST23).

The printer controller 99 receives the document data and associated data prepared by the PC 122 (ST24). The printer controller 99 develops image data in the page memory 98 using the font data stored in the printer font ROM 121 with a resolution corresponding to the resolution data added to the received document data (ST25).

In most of drivers of printers, the entire area of a physical sheet size is not set as a printable area. In general, an area less than the physical size by about 2 mm is set as a printable area. When a document prepared in this environment is to be printed on a tab sheet, it is necessary to shift an image by a degree greater than a tab width.

For example, printing is to be effected on an A4-size sheet, an area of 210 mm×297 mm is set in the page memory 98. If the tab width is set at 13 mm and printing is to be effected on an A4-size tab sheet, an area of 223 mm×297 mm is set.

However, considering the fact that the printable area is less than the physical size by about 2 mm as mentioned above, the tab sheet shift amount is set at 15 mm. Thereby, the area corresponding to the physical sheet size is set and the file-format image data is developed in the page memory 98.

The main CPU 91 executes a control to add white data corresponding to the width of 15 mm of the tab sheet shift amount to the image data in the page memory 98, on the basis of the information that the tab width amount is 13 mm and tab sheet shift amount is 15 mm, which is the data added to the document data (ST26).

After the image data has been developed in the page memory 98, the main CPU 91 controls the printer section 6 to effect printing on the tab sheet based on the image data developed in the page memory 98 (ST27).

The prior-art method and the present invention will now be compared.

In the prior-art method, it is presupposed that the original has a fixed size. Thus, according to this method, printing on the tab sheet is effected by shifting the image by an amount of the tab width. However, for example, when the original is a tab sheet and the area including the tab is an input image, the shift of the image is not needed but the image shifting is effected because the tab width amount is set.

Even if the original is of the fixed size, there may be a case where the image cannot be shifted to a position desired by the operator. In a case in the prior art where the tab width amount is also used for a purpose different from the image shifting, for example, for the sheet convey control, paper jamming or other problem will arise if the tab width amount is set at a size different from the actual size.

By contrast, in the present invention, the tab sheet shift amount, which is used for image shift in effecting printing on the tab sheet, is independently set. Thus, the operator can set image shifting to a position desired by the operator.

In the present invention, the tab sheet shift amount is independently set. Thus, the image shift is set to a position desired by the operator, whether the original size is of a regular size or an irregular size.

The present invention is applicable to both the copying function and the printer function, since the kind of originals is not limited to paper sheets or electronic files.

When the image forming apparatus of the present invention is used for the printer function, the setting of the tab sheet shift amount can be effected or altered by the client-side personal computer.

As described above, the tab sheet shift amount can be set by not only the image forming apparatus body but also the client-side personal computer.

The present invention is characterized in that the tab sheet shift amount is set independent from the tab width amount. The shift amount can be set by the image forming apparatus or personal computer.

Similarly, there are no limitations to the kind of originals (paper sheet/electronic data) or the original input means (copier, printer) for inputting originals to the image forming apparatus.

The tab width amount and tab sheet shift amount are applied to the case of printing on tab sheets, and not to the case of printing on regular-size sheets.

The printing functions using tab sheets include various modes wherein, for example, printing is successively effected on only tab sheets, tab sheets are interleaved for sectioning between regular-size printed sheets, and printing is effected tab sheets too and interleaved. The image shift printing using the tab sheet shift amount is applied to only the case of effecting printing on tab sheets.

As has been described above, according to the embodiment of the invention, the tab sheet shift amount is used. Thereby, the image shift control exclusive for the tab sheet printing can be executed independent from the other image shift function (e.g. binding margin provision).

Thus, the method of this invention may be combined with other image shift functions. For example, the binding margin provision function may be effected on regular-size sheets, and only the tab sheet shift amount may be used for printing on tab sheets.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus wherein a regular paper sheet or a tab sheet is fed and an image is formed on the fed regular paper sheet or tab sheet, the apparatus comprising:
an input section which inputs a tab width amount and a tab sheet shift amount when formation of an image on the tab sheet is set;
a read section that reads an image on an original, which is to be formed on the tab sheet;
a first control section which executes a control to shift the image data of the original read by the read section by the tab sheet shift amount input by the input section; and
a second control section which executes a control to form an image on the tab sheet on the basis of the image data shift-controlled by the first control section.

2. An image forming apparatus according to claim 1, wherein said input section inputs the amount of tab width of a tab sheet on which an image is to be formed, and a tab sheet shift amount that designates a shift amount of image data of the original to be read by the read section.

3. An image forming apparatus according to claim 1, wherein when the original read by the read section is of the same size and shape as the fed tab sheet, the tab sheet shift amount input by the input section is 0 mm.

4. An image forming apparatus according to claim 1, wherein when the tab sheet shift amount input by the input section is 0 mm, the control by the first control section is not executed.

5. An image forming apparatus according to claim 1, wherein the first control section executes a control to develop the image data of the original read by the read section into a page memory, and to add to the image data in the page memory white data corresponding to the tab sheet shift amount input by the input section.

6. An image forming apparatus wherein a regular paper sheet or a tab sheet is fed and an image is formed on the fed regular paper sheet or tab sheet, the apparatus comprising:
a receiving section which receives document data that has been transmitted, and associated data added to the document data;
a storage section which temporarily stores a tab width amount and a tab sheet shift amount added to the associated data, when the associated data received by the receiving section indicates setting of formation of an image on the tab sheet;
a first control section which executes a control to develop the document data received by the receiving section into image data, and to shift the image data by the tab sheet shift amount stored in the storage section; and
a second control section which executes a control to form an image on the tab sheet on the basis of the image data shift-controlled by the first control section.

7. An image forming apparatus according to claim 6, wherein the document data and associated data received by the receiving section is formed by a personal computer.

8. An image forming apparatus according to claim 6, wherein the document data and associated data received by the receiving section is transmitted from a personal computer connected over a communication line.

9. An image forming apparatus according to claim 6, wherein the associated data received by the receiving section includes instruction information for instructing formation of an image on the tab sheet, information on a tab width amount of the tab sheet on which an image is to be formed, and information on a tab sheet shift amount that designates a shift amount of image data.

10. An image forming method wherein a regular paper sheet or a tab sheet is fed and an image is formed on the fed regular paper sheet or tab sheet, the method comprising:
inputting a tab width amount and a tab sheet shift amount when formation of an image on the tab sheet is set;
reading an image on an original, which is to be formed on the tab sheet;
shifting the image data of the read original by the tab sheet shift amount; and
executing a control to form an image on the tab sheet on the basis of the shifted image data.
